(19) United States
(12) Patent Application Publication
(10) Pub. No.: US 2017/0300763 A1
(43) Pub. Date: Oct. 19, 2017

(54) ROAD FEATURE DETECTION USING A VEHICLE CAMERA SYSTEM

(71) Applicant: GM Global Technology Operations LLC, Detroit, MI (US)

(72) Inventors: Guangyu J. Zou, Warren, MI (US); Jinsong Wang, Troy, MI (US); Upali P. Mudalige, Oakland Township, MI (US); Shuqing Zeng, Sterling Heights, MI (US)

(21) Appl. No.: 15/486,638

(22) Filed: Apr. 13, 2017

Related U.S. Application Data
(60) Provisional application No. 62/324,606, filed on Apr. 19, 2016.

(51) Int. Cl. G06K 9/00; H04N 5/265; H04N 5/232; G06K 9/62; G01S 19/31; G06K 9/46; H04N 7/18; G06N 3/08; B60R 11/04; B60R 11/00

(52) U.S. Cl. CPC G06K 9/00798; H04N 7/181; H04N 5/265; H04N 5/23238; G06N 3/08; G06K 9/6269; G01S 19/31; G06K 9/4604; B60R 2011/004; B60R 11/04

(57) ABSTRACT

Examples of techniques for road feature detection using a vehicle camera system are disclosed. In one example implementation, a computer-implemented method includes receiving, by a processing device, an image from a camera associated with a vehicle on a road. The computer-implemented method further includes generating, by the processing device, a top view of the road based at least in part on the image. The computer-implemented method further includes detecting, by the processing device, lane boundaries of a lane of the road based at least in part on the top view of the road. The computer-implemented method further includes detecting, by the processing device, a road feature within the lane boundaries of the lane of the road using machine learning.

### CROSS-REFERENCE TO RELATED APPLICATION

This application claims the benefit of U.S. Provisional Patent Application No. 62/324,606, entitled “SURROUND VIEW CAMERA SYSTEM FOR MULTIPLE ROAD-FEATURE DETECTION,” filed Apr. 19, 2016, the disclosure of which is incorporated by reference herein in its entirety.

### INTRODUCTION

The present disclosure relates generally to vehicle cameras and more particularly to a surround view camera system for road feature detection, classification, and tracking.

A vehicle, such a car, motorcycle, a boat, or any other type of automobile may be equipped with one or more cameras to provide external views of the vehicle to a driver, other occupants of the vehicle, or the vehicle's built-in perception system. For example, a vehicle can include front, side, and/or rear cameras. Vehicles with cameras on all sides can implement a surround view camera system that provides a “bird's eye” or “top” view of the vehicle and its surroundings. Images from the cameras can be presented to the driver or another occupant of the vehicle on a display within the vehicle, such as on the dash, center stack, heads up display, etc. Additionally, images from the cameras can be used by the vehicle's perception computing system to detect objects and road features that are external to the vehicle.

### SUMMARY

In one exemplary embodiment, a computer-implemented method for road feature detection includes receiving, by a processing device, an image from a camera system associated with a vehicle on a road. The computer-implemented method further includes generating, by the processing device, a top view of the road based at least in part on the image. The computer-implemented method further includes detecting, by the processing device, lane boundaries of a lane of the road based at least in part on the top view of the road. The computer-implemented method further includes detecting, by the processing device, a road feature within the lane boundaries of the lane of the road using machine learning.

In some examples, the machine learning utilizes a convolutional neural network. In some examples, the machine learning utilizes an artificial neural network. In some examples, detecting the road feature within the lane boundaries further includes performing a feature extraction to extract road features from the top view using a neural network, and performing a classification of the road feature using the neural network. In some examples, the lane boundaries are defined by a lane marker, a road shoulder, or a curb. In some examples, detecting the lane boundaries comprises further includes detecting primitive features on the top view, performing clustering of the primitive features on the top view, performing curve fitting of the primitive features on the top view, and performing curve consolidation of the primitive features on the top view. In some examples, the camera includes a fisheye lens. In some examples, the road feature is one of a speed limit indicator, a bicycle lane indicator, a railroad indicator, a school zone indicator, and a direction indicator. An example method may additionally include adding the detected road feature to a database of road features, wherein the database of road features is accessible by other vehicles.

In another exemplary embodiment, a system for classifying roughness of a road includes a plurality of cameras associated with a vehicle. The system also includes a memory including computer readable instructions and a processing device for executing the computer readable instructions for performing a method. In examples, the method includes receiving, by a processing device, an image from each of the plurality of cameras. The method further includes, for each of the plurality of cameras, generating, by the processing device, a top view of the road based at least in part on the image, detecting, by the processing device, lane boundaries of a lane of the road based at least in part on the top view of the road, and detecting, by the processing device, a road feature within the lane boundaries of the lane of the road using machine learning. The method further includes fusing, by the processing device, the road features from each of the plurality of cameras.

An example method may additionally include performing a time synchronization for each of the plurality of cameras. An example method may additionally include applying the time synchronization to the fusing the road features from each of the plurality of cameras. An example method may additionally include receiving sensor data from a sensor associated with the car. In some examples, the fusion of the road features from each of the plurality of cameras further comprises fusing the road features from each of the plurality of cameras with the sensor data In some examples, the sensor data is generated by a light detection and ranging (LIDAR) sensor associated with the vehicle. In some examples, the sensor data is generated by a long-range camera associated with the vehicle. In some examples, the sensor data is global positioning system data.

In yet another exemplary embodiment a computer program product for road feature detection includes a computer readable storage medium having program instructions embodied therewith, wherein the computer readable storage medium is not a transitory signal per se, the program instructions executable by a processing device to cause the processing device to perform a method. In examples, the method includes receiving, by a processing device, an image from a camera associated with a vehicle on a road. The method further includes generating, by the processing device, a top view of the road based at least in part on the image. The method further includes detecting, by the processing device, lane boundaries of a lane of the road based at least in part on the top view of the road. The method further includes detecting, by the processing device, a road feature within the lane boundaries of the lane of the road using machine learning.

In some examples, the machine learning utilizes a convolutional neural network. In some examples, the machine learning utilizes an artificial neural network. In some examples, detecting the road feature within the lane boundaries further includes performing a feature extraction to extract road features from the top view using a neural network, and performing a classification of the road feature using the neural network. In some examples, the lane boundaries are defined by a lane marker, a road shoulder, or a curb. The above features and advantages, and other features and advantages, of the disclosure are readily apparent from the following detailed description when taken in connection with the accompanying drawings.

### BRIEF DESCRIPTION OF THE DRAWINGS

Other features, advantages, and details appear, by way of example only, in the following detailed description, the detailed description referring to the drawings in which:

FIG. 1 depicts a vehicle including a processing system for road feature detection, according to aspects of the present disclosure;

FIG. 2 depicts the processing system of FIG. 1, according to aspects of the present disclosure;

FIG. 3 depicts image processing of images associated with lane boundary detection, according to aspects of the present disclosure;

FIGS. 4A and 4B depict neural networks used for detecting road features, according to aspects of the present disclosure;

FIG. 5 depicts a flow diagram of a method for road feature detection, according to aspects of the present disclosure;

FIG. 6 depicts a flow diagram of a method for road feature detection, according to aspects of the present disclosure; and

FIG. 7 depicts a block diagram of a processing system for implementing the techniques described herein, according to aspects of the present disclosure.

### DETAILED DESCRIPTION

The following description is merely exemplary in nature and is not intended to limit the present disclosure, its application or uses. It should be understood that throughout the drawings, corresponding reference numerals indicate like or corresponding parts and features. As used herein, the term module refers to processing circuitry that may include an application specific integrated circuit (ASIC), an electronic circuit, a processor (shared, dedicated, or group) and memory that executes one or more software or firmware programs, a combinational logic circuit, and/or other suitable components that provide the described functionality.

The technical solutions described herein provide for road feature detection using a camera of a vehicle. For example, the present techniques use a surround camera system of a vehicle to detect, track, and classify close range road features reliability and in real-time. Road features include lane marks, traffic direction control indicators, curbs, shoulders, and the like that are located on or about the road surface. To detect road features, the present techniques implement a deep learning network to enable multiple road feature detection and classification in parallel as one step and in real-time. In some examples, the road features can be fused with other in-vehicle sensors/data (e.g., long range sensors, other cameras, LIDAR sensors, maps, etc.) to improve detection and classification accuracy and robustness. In additional examples, the road features can be used for self-mapping and crowdsourcing to generate and/or update a road feature database.

Processing resources present a challenge when detecting multiple road features from high-resolution camera images/data. Existing approaches for road feature detection use multiple algorithms instead of deep learning to detect road features. Such existing approaches are hardware/processor intensive, time-consuming, and inefficient.

Example embodiments of the disclosure include or yield various technical features, technical effects, and/or improvements to technology. Example embodiments of the disclosure provide for road feature detection using machine learning to address computational inefficiency and accuracy issues in existing road feature detection. More particularly, the embodiments described herein detect road features by generating a top view of a road based on an image from a camera associated with a vehicle on the road, detect lane boundaries of a lane of the road based on the top view of the road, and detect (e.g., using deep learning) a road feature within the lane boundaries of the lane of the road. These aspects of the disclosure constitute technical features that yield the technical effect of reducing overall computational load, power consumption, hardware costs, and time.

Accordingly, the present techniques improve the functioning of processing systems used to detect road features as described herein. As a result of these technical features and technical effects, the techniques described herein represent an improvement to existing road feature detection techniques. It should be appreciated that the above examples of technical features, technical effects, and improvements to technology of example embodiments of the disclosure are merely illustrative and not exhaustive.

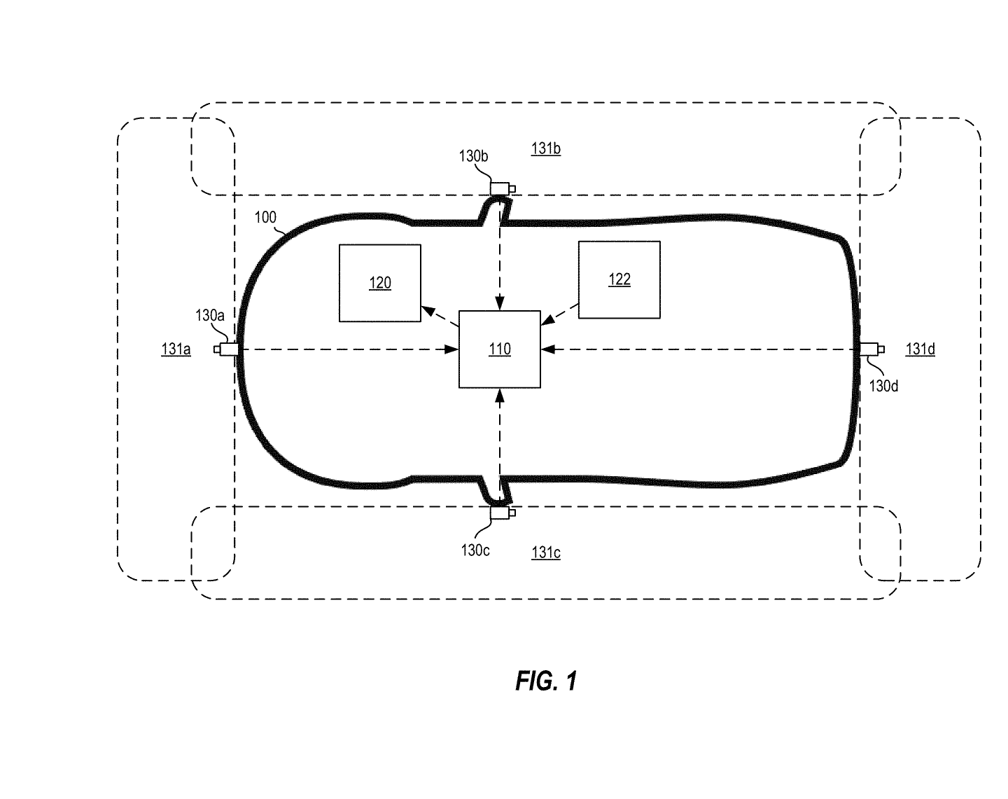

FIG. 1 depicts a vehicle 100 including a processing system 110 for road feature detection, according to aspects of the present disclosure. In addition to the processing system 110, the vehicle 100 includes a display 120, a sensor suite 122, and cameras 130a, 130b, 130c, 130d (collectively referred to herein as “cameras 130”). The vehicle 100 can be a car, truck, van, bus, motorcycle, boat, plane, or another suitable vehicle 100.

The cameras 130 capture images external to the vehicle 100. Each of the cameras 130 has a field-of-view (FOV) 131a, 131b, 131c, 131d (collectively referred to herein as “FOV 131”). The FOV is the area observable by a camera. For example, the camera 130a has an FOV 131a, the camera 131b has an FOV 131b, the camera 130c has an FOV 131c, and the camera 131d has an FOV 131d. The captured images can be the entire FOV for the camera or can be a portion of the FOV of the camera.

According to aspects of the present disclosure, although four cameras 130a-130d are shown, different numbers of cameras (e.g., 2 cameras, 3 cameras, 5 cameras, 8 cameras, 9 cameras, etc.) can be implemented. The captured images can be displayed on the display 120 to provide external views of the vehicle 100 to the driver/operator or another occupant of the vehicle 100. The captured images can be displayed on the display 120 as live images, still images, or some combination thereof. The display 120 can be a full display mirror (FDM) which is enabled to display images from one or more of the cameras 130. The FDM can be a traditional mirror in one mode or can be a display 120 for displaying digital images in another mode.

It should be appreciated that the captured image(s) can be an image from one of the cameras 130a-130d and/or can be a combination of images from more than one of the cameras 130a-130d. According to embodiments of the present disclosure, the captured images from the cameras 130 can be combined to form a top view or “bird's eye” view that provides a surround view around the vehicle 100. It should be appreciated that camera images can be displayed by any other in-vehicle displays, such as a center stack display, and camera images can be from any other interior or exterior vehicle cameras.

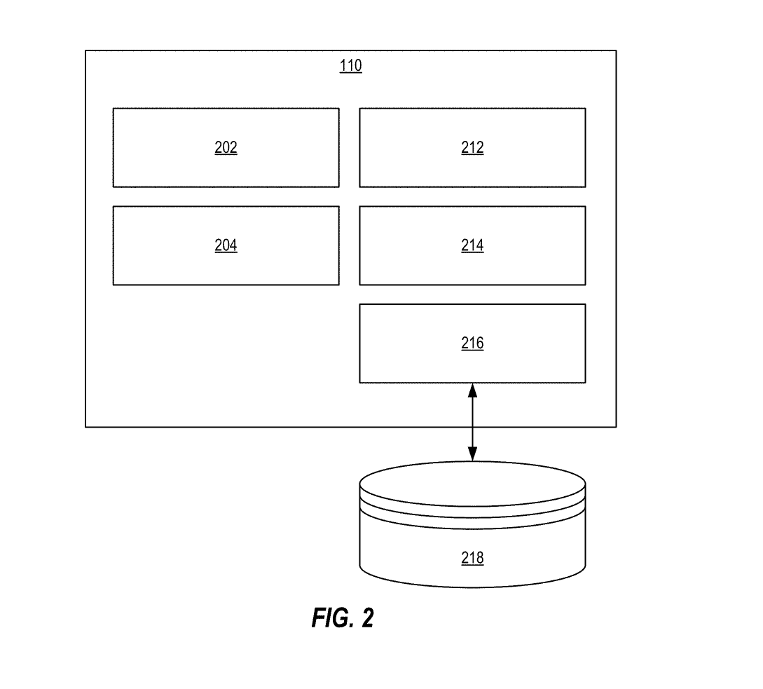

As described herein, the processing system 110 receives an image from a camera associated with a vehicle on a road, generates a top view of the road based at least in part on the image, detects lane boundaries of a lane of the road based at least in part on the top view of the road, and detects a road feature within the lane boundaries of the lane of the road using machine learning and/or computer vision techniques. The processing system 110 is described in more detail with regard to FIG. 2. The processing system 110 can also receive sensor data from the sensor suite 122, which can be one or more of a light detection and ranging (LIDAR) sensor, a long-range camera, a global positioning system (GPS), etc. The sensor data can be used to enhance the road feature detection.

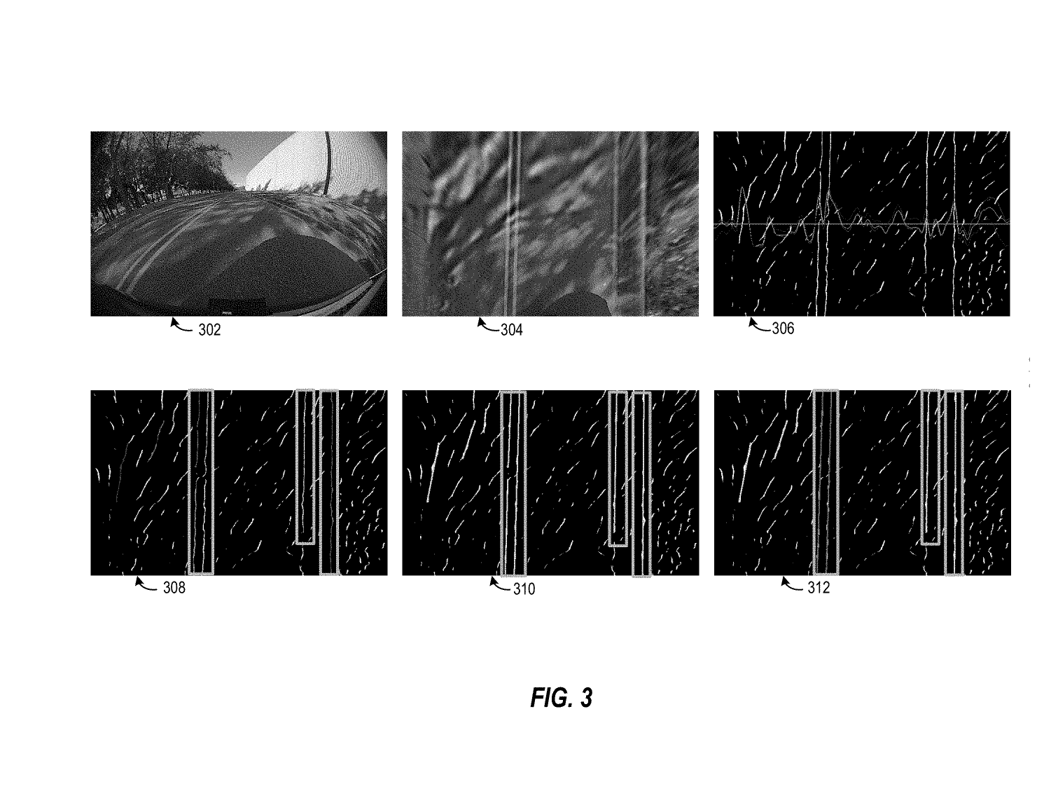

In particular, FIG. 2 depicts the processing system 110 of FIG. 1, according to aspects of the present disclosure. The processing system 110 includes a processing device 202, a memory 204, a top view generation engine 212, a lane boundaries detection engine 214, and a road feature detection engine 216. FIG. 2 is described with respect to the vehicle 100 of FIG. 1. FIG. 2 is also described with respect to FIG. 3, which depicts image processing of images 302, 304, 306, 308, 310, 312 associated with lane boundary detection, according to aspects of the present disclosure.

The various components, modules, engines, etc. described regarding FIG. 2 can be implemented as instructions stored on a computer-readable storage medium, as hardware modules, as special-purpose hardware (e.g., application specific hardware, application specific integrated circuits (ASICs), as embedded controllers, hardwired circuitry, etc.), or as some combination or combinations of these.

In examples, the engine(s) described herein can be a combination of hardware and programming. The programming can be processor executable instructions stored on a tangible memory, and the hardware can include the processing device 202 for executing those instructions. Thus a system memory (e.g., the memory 204) can store program instructions that when executed by the processing device 202 implement the engines described herein. Other engines can also be utilized to include other features and functionality described in other examples herein. Alternatively or additionally, the processing system 110 can include dedicated hardware, such as one or more integrated circuits, ASICs, application specific special processors (ASSPs), field programmable gate arrays (FPGAs), or any combination of the foregoing examples of dedicated hardware, for performing the techniques described herein.

The top view generation engine 212 receives an image (e.g., original image 302) from a camera (e.g., one of the cameras 130) of the vehicle 100. The image includes a portion of a road upon which the vehicle 100 is positioned and/or along which the vehicle 100 travels. The top view generation engine 212 generates a top view of the road based at least in part on the image. That is, the top view generation engine 212 uses the image to generate a top view of the road as if the point of view of the camera was directly above the road looking down at the road. An example of a top view (e.g., top-down view 304) is depicted in FIG. 3.

According to aspects of the present disclosure, the top view generation engine 212 uses fisheye camera imaging techniques to generate the top view from an image captured with a fisheye camera (i.e., a camera having a fisheye lens). When using a fisheye camera, the top view generation engine 212 can be calibrated to compensate for radial distortion caused by the fisheye lens.

Once the top view is generated, the lane boundaries detection engine 214 detects lane boundaries of a lane of the road based on the top view of the road. Lanes can be bounded by lane markers, curbs, shoulders, or other visual indicators that indicate a lane in which a vehicle is to travel. The lane boundary detection engine 214 can detect lane boundaries by detecting feature primitives (points, segments, etc.) on the top view (see, e.g., lane boundary feature detection 306), performing clustering of the feature primitives on the top view (see, e.g., feature primitive clustering 308), performing curve fitting of the feature primitives on the top view (see, e.g., curve fitting 310), and performing curve consolidation of the feature primitives on the top view (see, e.g., curve consolidation 312). Detecting lane boundaries enables the detection of road features within the lane boundaries. In particular, the final image (e.g., curve consolidation 312, also referred to as “boundary image 312”) is used to detect road features, although the road features can be detected using other images according to aspects of the present disclosure.

Once the lane boundaries of the lane are detected, the road feature detection engine 216 uses the lane boundaries to detect road features within the lane boundaries of the lane of the road using machine learning and/or computer vision techniques. The road feature detection engine 216 searches within the top view, as defined by the lane boundaries, to detect road features. The road feature detection engine 216 can determine a type of road feature (e.g., a straight arrow, a left-turn arrow, etc.) as well as a location of the road feature (e.g., arrow ahead, bicycle lane to the left, etc.).

The road features can be predefined in a database of road features (e.g., road feature database 218). Examples of road features include a speed limit indicator, a bicycle lane indicator, a railroad indicator, a school zone indicator, and a direction indicator (e.g., left-turn arrow, straight arrow, right-turn arrow, straight and left-turn arrow, straight and right-turn arrow, etc.), and the like. The road feature database 218 can be updated when road features are detected, and the road feature database 218 can be accessible by other vehicles, such as from a cloud computing environment over a network or from the vehicle 100 directly (e.g., using direct short-range communications (DSCR)). This enables crowd-sourcing of road features.

To detect road features, the road feature detection engine 216 uses machine learning and computer vision techniques. More specifically, the road feature detection engine 216 can incorporate and utilize rule-based decision making and artificial intelligent (AI) reasoning to accomplish the various operations described herein. The phrase “machine learning” broadly describes a function of electronic systems that learn from data. A machine learning system, engine, or module can include a trainable machine learning algorithm that can be trained, such as in an external cloud environment, to learn functional relationships between inputs and outputs that are currently unknown, and the resulting model can be used by the road feature detection engine 216 to detect road features.

In one or more embodiments, machine learning functionality can be implemented using an artificial neural network (ANN) having the capability to be trained to perform a currently unknown function. In machine learning and cognitive science, ANNs are a family of statistical learning models inspired by the biological neural networks of animals, and in particular the brain. ANNs can be used to estimate or approximate systems and functions that depend on a large number of inputs. In another embodiment, machine learning functionality can be implemented using a convolutional neural network (CNN). A CNN is a type of feed-forward ANN. Machine learning can be implemented using any suitable type of neural networks.

ANNs can be embodied as so-called “neuromorphic” systems of interconnected processor elements that act as simulated “neurons” and exchange “messages” between each other in the form of electronic signals. Similar to the so-called “plasticity” of synaptic neurotransmitter connections that carry messages between biological neurons, the connections in ANNs that carry electronic messages between simulated neurons are provided with numeric weights that correspond to the strength or weakness of a given connection. The weights can be adjusted and tuned based on experience, making ANNs adaptive to inputs and capable of learning. For example, an ANN for handwriting recognition is defined by a set of input neurons that can be activated by the pixels of an input image. After being weighted and transformed by a function determined by the network's designer, the activation of these input neurons are then passed to other downstream neurons, which are often referred to as “hidden” neurons. This process is repeated until an output neuron is activated. The activated output neuron determines which character was read.

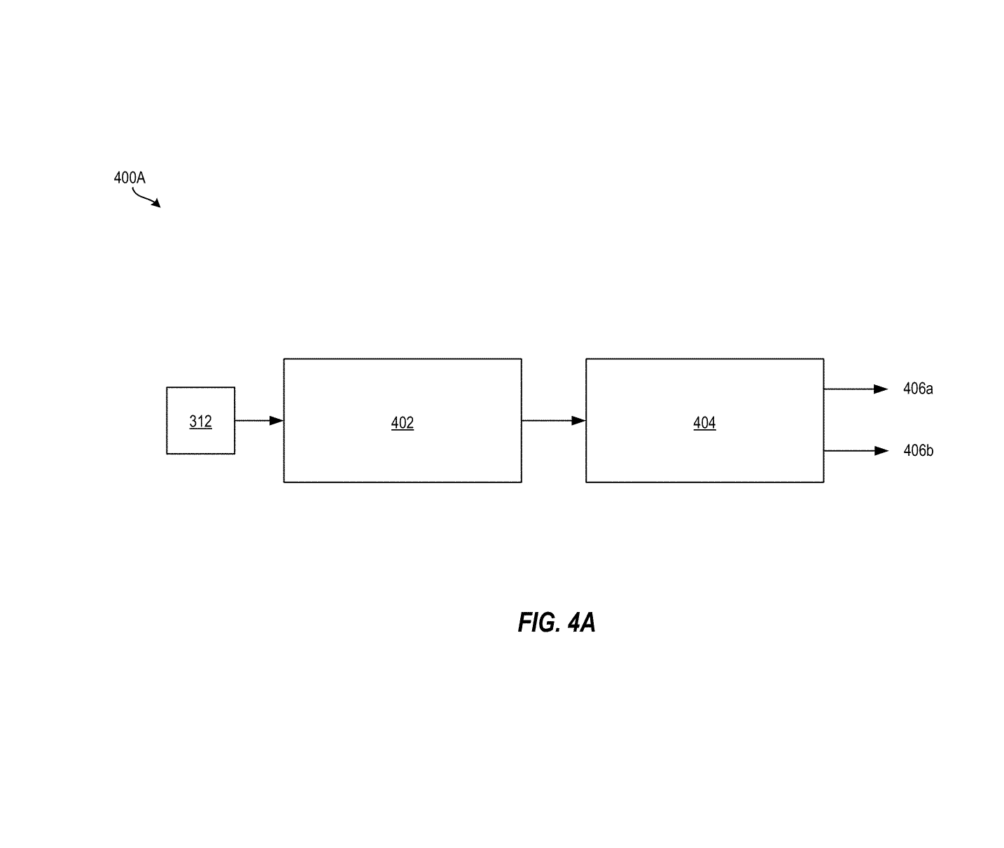

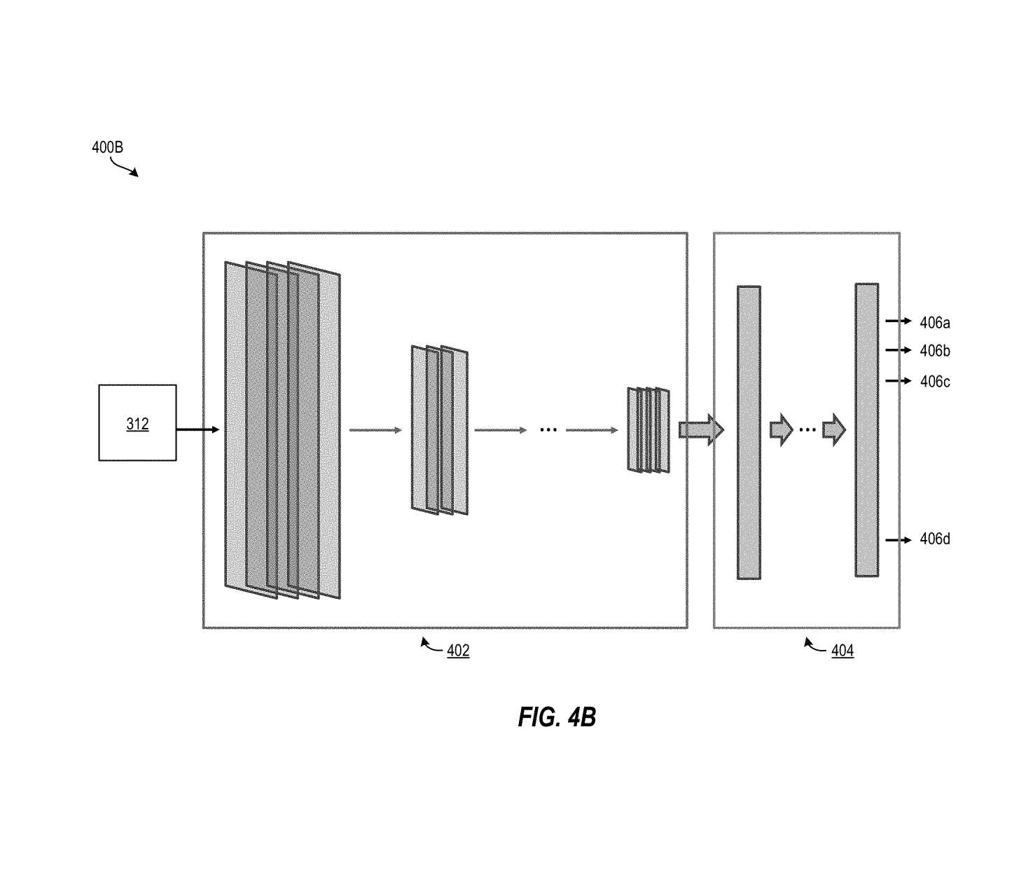

FIGS. 4A and 4B depict neural networks 400A, 400B used for detecting road features, according to aspects of the present disclosure. As depicted in FIG. 4A, the road feature detection engine 216 can detect road features by performing a feature extraction 402 to extract road features using a neural network, and then performing a classification 404 using the neural network. FIG. 4B depicts the feature extraction 402 and classification 404 in more detail as an example using a convolutional neural network.

Feature extraction takes as an input the boundary image 312, which represents the result of the image processing depicted in FIG. 3 as performed by the top view generation engine 212 and the lane boundaries detection engine 214. The feature extraction 402 uses a neural network, as described herein, to extract road features, for example, using feature maps. The feature extraction 402 outputs the road features to the classification 404 to classify the road features, such as based on road features stored in the road feature database 218. The classification 404 outputs the road features 406a, 406b, 406c, 406d, etc., which can be a speed limit indicator, a bicycle lane indicator, a railroad indicator, a school zone indicator, a direction indicator, or other road feature.

It should be appreciated that the road feature detection engine 216, using the feature detection 402 and classification 404, can detect multiple road features (e.g., road features 406a, 406b, 406e, 406d, etc.) in parallel as one step and in real-time. By using machine learning, computational inefficiency and accuracy issues in existing road feature detection can be reduced.

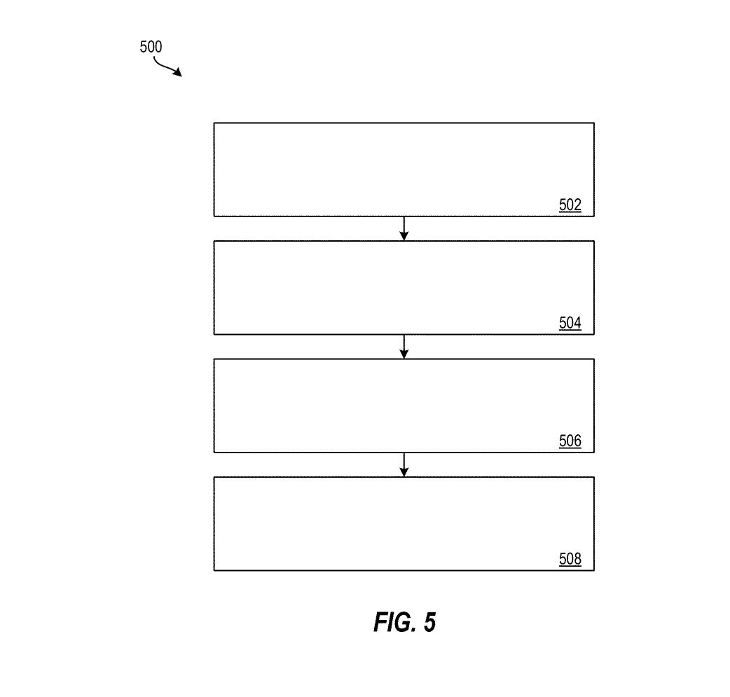

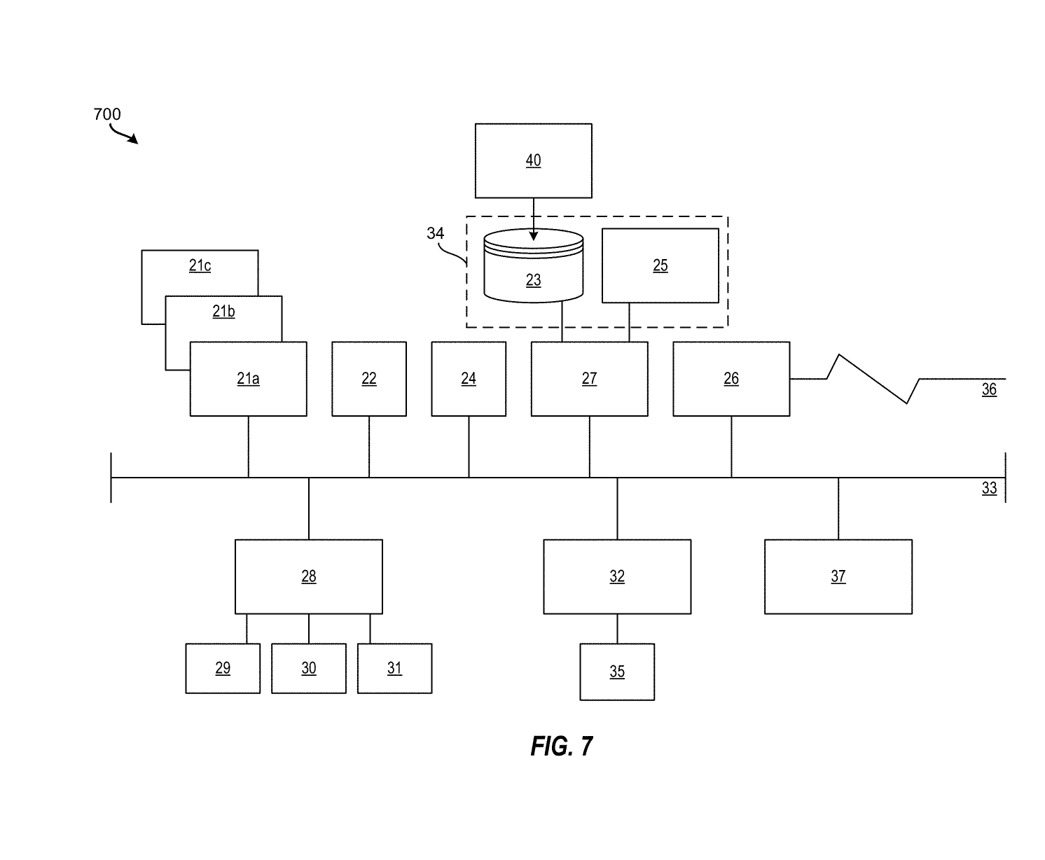

FIG. 5 depicts a flow diagram of a method 500 for road feature detection, according to aspects of the present disclosure. The method 500 can be implemented, for example, by the processing system 110 of FIGS. 1 and 2, by the processing system 700 of FIG. 7, or by another suitable processing system or device.

At block 502 the processing system 110 receives an image from a camera associated with a vehicle on a road. At block 504 the top view generation engine 212 generates a top view of the road based at least in part on the image.

At block 506, the lane boundaries detection engine 214 detects lane boundaries of a lane of the road based at least in part on the top view of the road. The lane boundaries detection engine can detect lane boundaries as described and depicted with respect to FIG. 3.

At block 508, the road feature detection engine 216 detects a road feature within the lane boundaries of the lane of the road using machine learning (e.g., a convolutional neural network, an artificial neural network, etc.). The road feature detection engine 216 can perform feature extraction from the top view (within the lane boundaries) using a neural network and then perform a classification of the road features (e.g., determine what kind of road feature).

Additional processes also can be included, and it should be understood that the processes depicted in FIG. 5 represent illustrations and that other processes can be added or existing processes can be removed, modified, or rearranged without departing from the scope and spirit of the present disclosure.

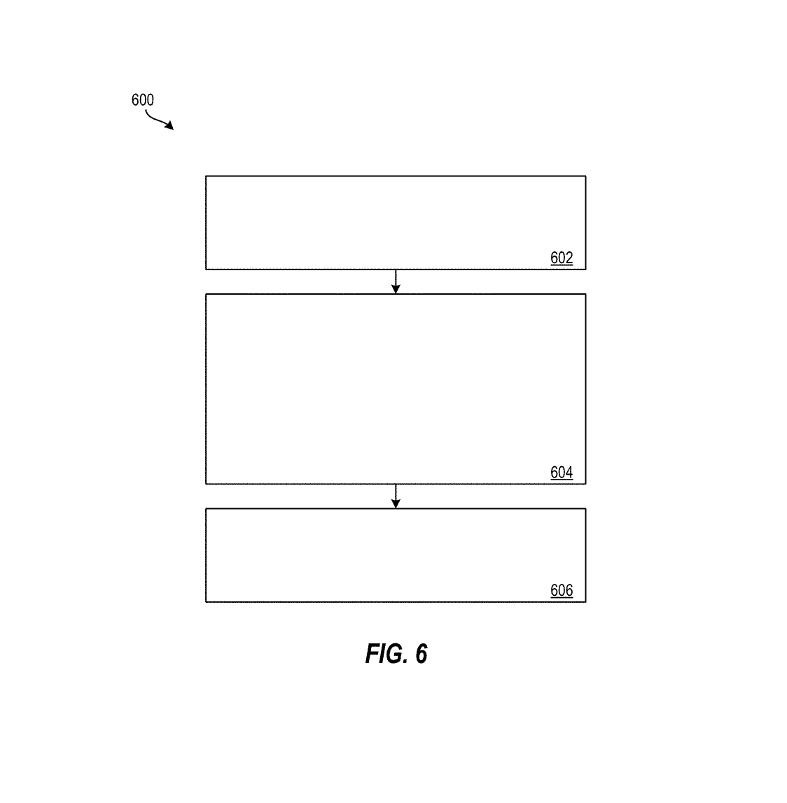

FIG. 6 depicts a flow diagram of a method 600 for road feature detection, according to aspects of the present disclosure. The method 600 can be implemented, for example, by the processing system 110 of FIGS. 1 and 2, by the processing system 700 of FIG. 7, or by another suitable processing system or device. In particular, the method 600 provides for coordinating multi-camera fusion of images from a plurality of cameras (e.g., the cameras 130a, 130b, 130c, 130d).

At block 602, the processing system 110 receives an image from each of the cameras 130. At block 604, for each of the cameras 130, following occurs: the top view generation engine 212 generates a top view of the road based on the image; the lane boundaries detection engine 214 detects lane boundaries of a lane of the road based on the top view; and the road feature detection engine 216 detects a road feature within the lane boundaries of the lane of the road using machine learning. The road feature detection engine can detect multiple road features.

At block 606, a fusion engine (not shown) first fuses the lane boundary information from each of the cameras, then based on consolidated lane information, fuses road features from each of the cameras. Fusing the road features from each of the cameras provides for uninterrupted and accurate road feature detecting by predicting road feature locations when a road feature passes from the FOV of one camera to the FOV of another camera, when a road feature is partially obstructed in the FOV of one or more cameras, and the like.

The fusion can also include fusing data from sensors (e.g., the sensor suite 122) in the vehicle 100. For example, the method 600 can include receiving sensor data from the sensor suite 122. The sensor can be a long range sensor, another camera, a LIDAR sensor, GPS, and the like and suitable combinations thereof. Accordingly, fusing the road features from each of the plurality of cameras can further include fusing the road features from each of the plurality of cameras with the sensor data. A timing signal can also be applied to the cameras 130, the fusion engine, and the sensor suite 122 to apply time synchronization for the cameras 130, the fusion engine, and the sensor suite 122. This enables the road feature detection to provide feedback and context information that aids surround view cameras (e.g., the cameras 130) to perform image processing as described herein.

Additional processes also can be included, and it should be understood that the processes depicted in FIG. 6 represent illustrations and that other processes can be added or existing processes can be removed, modified, or rearranged without departing from the scope and spirit of the present disclosure.

It is understood that the present disclosure is capable of being implemented in conjunction with any other type of computing environment now known or later developed. For example, FIG. 7 illustrates a block diagram of a processing system 700 for implementing the techniques described herein. In examples, processing system 700 has one or more central processing units (processors) 21a, 21b, 21c, etc. (collectively or generically referred to as processor(s) 21 and/or as processing device(s)). In aspects of the present disclosure, each processor 21 can include a reduced instruction set computer (RISC) microprocessor. Processors 21 are coupled to system memory (e.g., random access memory (RAM) 24) and various other components via a system bus 33. Read only memory (ROM) 22 is coupled to system bus 33 and can include a basic input/output system (BIOS), which controls certain basic functions of processing system 700.

Further illustrated are an input/output (I/O) adapter 27 and a network adapter 26 coupled to system bus 33. I/O adapter 27 can be a small computer system interface (SCSI) adapter that communicates with a hard disk 23 and/or other storage drive 25 or any other similar component. I/O adapter 27, hard disk 23, and storage device 25 are collectively referred to herein as mass storage 34. Operating system 40 for execution on processing system 700 can be stored in mass storage 34. A network adapter 26 interconnects system bus 33 with an outside network 36 enabling processing system 700 to communicate with other such systems.

A display (e.g., a display monitor) 35 is connected to system bus 33 by display adaptor 32, which can include a graphics adapter to improve the performance of graphics and general computation intensive applications and a video controller. In one aspect of the present disclosure, adapters 26, 27, and/or 32 can be connected to one or more I/O buses that are connected to system bus 33 via an intermediate bus bridge (not shown). Suitable I/O buses for connecting peripheral devices such as hard disk controllers, network adapters, and graphics adapters typically include common protocols, such as the Peripheral Component Interconnect (PCI). Additional input/output devices are shown as connected to system bus 33 via user interface adapter 28 and display adapter 32. A keyboard 29, mouse 30, and speaker 31 can be interconnected to system bus 33 via user interface adapter 28, which can include, for example, a Super I/O chip integrating multiple device adapters into a single integrated circuit.

In some aspects of the present disclosure, processing system 700 includes a graphics processing unit 37. Graphics processing unit 37 is a specialized electronic circuit designed to manipulate and alter memory to accelerate the creation of images in a frame buffer intended for output to a display. In general, graphics processing unit 37 is very efficient at manipulating computer graphics and image processing, and has a highly parallel structure that makes it more effective than general-purpose CPUs for algorithms where processing of large blocks of data is done in parallel.

Thus, as configured herein, processing system 700 includes processing capability in the form of processors 21, storage capability including system memory (e.g., RAM 24), and mass storage 34, input means such as keyboard 29 and mouse 30, and output capability including speaker 31 and display 35. In some aspects of the present disclosure, a portion of system memory (e.g., RAM 24) and mass storage 34 collectively store an operating system to coordinate the functions of the various components shown in processing system 700.

The descriptions of the various examples of the present disclosure have been presented for purposes of illustration, but are not intended to be exhaustive or limited to the embodiments disclosed. Many modifications and variations will be apparent to those of ordinary skill in the art without departing from the scope and spirit of the described techniques. The terminology used herein was chosen to best explain the principles of the present techniques, the practical application or technical improvement over technologies found in the marketplace, or to enable others of ordinary skill in the art to understand the techniques disclosed herein.

While the above disclosure has been described with reference to exemplary embodiments, it will be understood by those skilled in the art that various changes can be made and equivalents can be substituted for elements thereof without departing from its scope. In addition, many modifications can be made to adapt a particular situation or material to the teachings of the disclosure without departing from the essential scope thereof. Therefore, it is intended that the present techniques not be limited to the particular embodiments disclosed, but will include all embodiments falling within the scope of the application.

What is claimed is:

1. A computer-implemented method for road feature detection, the method comprising:
receiving, by a processing device, an image from a camera system associated with a vehicle on a road;
generating, by the processing device, a top view of the road based at least in part on the image;
detecting, by the processing device, lane boundaries of a lane of the road based at least in part on the top view of the road; and
detecting, by the processing device, a road feature within the lane boundaries of the lane of the road using machine learning.

2. The computer-implemented method of claim 1, wherein the machine learning utilizes a convolutional neural network.

3. The computer-implemented method of claim 1, wherein the machine learning utilizes an artificial neural network.

4. The computer-implemented method of claim 1, wherein detecting the road feature within the lane boundaries further comprises:
performing a feature extraction to extract road features from the top view using a neural network; and
performing a classification of the road feature using the neural network.

5. The computer-implemented method of claim 1, wherein the lane boundaries are defined by a lane marker, a road shoulder, or a curb.

6. The computer-implemented method of claim 1, wherein detecting the lane boundaries comprises further comprises:
detecting feature primitives on the top view;
performing clustering of the feature primitives on the top view;
performing curve fitting of the feature primitives on the top view; and
performing curve consolidation of the feature primitives on the top view.

7. The computer-implemented method of claim 1, wherein the camera comprises a fisheye lens.

8. The computer-implemented method of claim 1, wherein the road feature is selected from the group consisting of a speed limit indicator, a bicycle lane indicator, a railroad indicator, a school zone indicator, and a direction indicator.

9. The computer-implemented method of claim 1, further comprising adding the detected road feature to a database of road features, wherein the database of road features is accessible by other vehicles.

10. A system for road feature detection, the system comprising:
a plurality of cameras associated with a vehicle;
a memory comprising computer readable instructions; and
a processing device for executing the computer readable instructions for performing a method, the method comprising:
receiving, by a processing device, an image from each of the plurality of cameras;
for each of the plurality of cameras,
generating, by the processing device, a top view of the road based at least in part on the image,
detecting, by the processing device, lane boundaries of a lane of the road based at least in part on the top view of the road, and
detecting, by the processing device, a road feature within the lane boundaries of the lane of the road using machine learning; and
fusing, by the processing device, the road features from each of the plurality of cameras.

11. The system of claim 10, wherein the method further comprises performing a time synchronization for each of the plurality of cameras.

12. The system of claim 11, wherein the method further comprises applying the time synchronization to the fusing the road features from each of the plurality of cameras.

13. The system of claim 10, wherein the method further comprises:
receiving other sensor data modalities from a sensor suite associated with the car,
wherein the fusing the road features from each of the plurality of cameras further comprises fusing the road features from each of the plurality of cameras with the sensor data.

14. The system of claim 13, wherein the sensor data is generated by a light detection and ranging (LIDAR) sensor associated with the vehicle.

15. The system of claim 13, wherein the sensor data is generated by a long-range camera associated with the vehicle.

16. The system of claim 13, wherein the sensor data is global positioning system data.

17. A computer program product for road feature detection, the computer program product comprising:
a computer readable storage medium having program instructions embodied therewith, wherein the computer readable storage medium is not a transitory signal per se, the program instructions executable by a processing device to cause the processing device to perform a method comprising:
receiving, by a processing device, an image from a camera associated with a vehicle on a road;
generating, by the processing device, a top view of the road based at least in part on the image;
detecting, by the processing device, lane boundaries of a lane of the road based at least in part on the top view of the road; and
detecting, by the processing device, a road feature within the lane boundaries of the lane of the road using machine learning.

18. The computer program product of claim 17, wherein the machine learning utilizes a convolutional neural network.

19. The computer program product of claim 17, wherein the machine learning utilizes an artificial neural network.

20. The computer program product of claim 17, wherein detecting the road feature within the lane boundaries further comprises:
performing a feature extraction to extract road features from the top view using a neural network; and
performing a classification of the road feature using the neural network.
